(19) United States
(12) Patent Application Publication
(10) Pub. No.: US 2025/0179296 A1
(43) Pub. Date: Jun. 5, 2025

(54) THERMOPLASTIC COMPOSITIONS

(71) Applicant: SHPP GLOBAL TECHNOLOGIES B.V., Bergen op Zoom (NL)

(72) Inventors: Xing LIU, Shanghai (CN); Wei SHAN, Shanghai (CN); Yun ZHENG, Shanghai (CN); Rui GAO, Shanghai (CN); Yunan CHENG, Shanghai (CN)

(21) Appl. No.: 18/832,381

(22) PCT Filed: Jan. 13, 2023
(86) PCT No.: PCT/IB2023/050328

§ 371 Date: Jul. 23, 2024

(30) Foreign Application Priority Data
Feb. 1, 2022 (EP) 22154557.7

(51) Int. Cl. C08L 69/00; C08K 5/42

(52) U.S. Cl. CPC C08L 69/00; C08K 5/42; C08L 2201/02; C08L 2203/30; C08L 2205/025; C08L 2205/035; C08L 2207/53

(57) ABSTRACT

A thermoplastic composition includes particular amounts of a polycarbonate; a brominated polycarbonate; a poly(aliphatic ester-carbonate); a silicone-containing impact modifier; and a flame retardant. Articles including the composition and methods for the manufacture thereof are also disclosed.

### CROSS REFERENCE TO RELATED APPLICATION

This application claims priority to and the benefit of European Patent Application No. 22154557.7, filed on Feb. 1, 2022, the contents of which are incorporated by reference herein in their entirety.

### BACKGROUND

This disclosure relates to thermoplastic compositions, and in particular to thermoplastic polycarbonate compositions, methods of manufacture, and uses thereof.

Polycarbonates are useful in the manufacture of articles and components for a wide range of applications, from automotive parts to electronic appliances. Because of their broad use, particularly in electrical applications, it is desirable to provide polycarbonates with improved hydrolytic stability and electrical tracking resistance.

There accordingly remains a need in the art for thermoplastic compositions that have improved hydrolytic stability and electrical tracking resistance. It would be a further advantage if thermoplastic compositions had good low-temperature impact resistance and good flame retardance.

### SUMMARY

A thermoplastic composition comprises 45 to 90 weight percent of a polycarbonate; 5 to 15 weight percent of a brominated polycarbonate; 1 to 20 weight percent of a poly(aliphatic ester-carbonate); 2 to 10 weight percent of a silicone-containing impact modifier; and 0.1 to 1 weight percent of a flame retardant comprising an alkyl sulfonate salt, aromatic sulfone sulfonate, an aromatic sulfonate salt, or a combination thereof; wherein the weight percent of each component is based on the total weight of the composition.

In another aspect, a method of manufacture comprises combining the above-described components to form a thermoplastic composition.

In yet another aspect, an article comprises the above-described thermoplastic composition.

In still another aspect, a method of manufacture of an article comprises molding, extruding, or shaping the above-described thermoplastic composition into an article.

The above described and other features are exemplified by the following detailed description.

### DETAILED DESCRIPTION

Conventional thermoplastic compositions presently used in electrical connectors may not meet high-end (e.g., 1500 V) application requirements with respect to electrical tracking over the entire 300-600 V range, while also providing hydrolytic stability, low-temperature impact performance, and flame retardance. The inventors hereof have discovered thermoplastic compositions with improved electrical properties over the entire 300-600 V range, improved tracking performance, low temperature impact properties, and flame retardance. The thermoplastic compositions include a polycarbonate, a brominated polycarbonate, a polyester-carbonate, an impact modifier, and a particular flame retardant. The thermoplastic compositions have improved tracking performance, wherein a molded sample of the composition does not show tracking after 50 drops of 0.1% ammonium chloride solution measured across the full range from 300 to 600 V, each as determined by ASTM D-3638-85. The hydrolytic stability of the thermoplastic compositions is also improved, wherein a molded sample of the composition displays improved molecular weight retention as compared with conventional formulations, for example, greater than 85% (1000 hours) as measured in a hydrolytic chamber at 85° C. and 85% relative humidity. The impact performance is maintained, wherein a molded sample (3.2 mm) of the composition can have a notched Izod impact of greater than 600 Joules per meter (J/m) at −30° C. In a further advantageous feature, the compositions can achieve a V0 UL94 flame rating at a thickness of 1.2 millimeters. A significant improvement is therefore provided by the composition of the present disclosure.

Accordingly, an aspect of the present disclosure is a thermoplastic composition. The composition comprises a polycarbonate. “Polycarbonate” as used herein means a polymer having repeating structural carbonate units of formula (1)

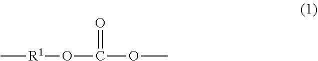

in which at least 60% of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2) HO-A¹-Y¹-A²-OH (2) wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

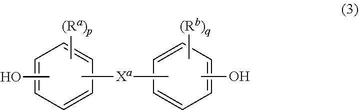

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The C₁₋₆₀ organic group can be disposed such that the C₆ arylene groups connected thereto are each connected to a common alkylidene carbon or to different carbons of the C₁₋₆₀ organic bridging group. In an aspect, p and q are each 1, and R^{a} and R^{b} are each a C₁₋₃ alkyl group, preferably methyl, disposed meta to the hydroxy group on each arylene group.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination can also be used. In a specific aspect, the polycarbonate is a linear homopolymer derived from bisphenol A, in which each of A¹ and A² is p-phenylene and Y¹ is isopropylidene in formula (3).

The thermoplastic compositions can include a homopolycarbonate (wherein each R¹ in the polymer is the same). In an aspect, the homopolycarbonate in the thermoplastic composition is derived from a bisphenol of formula (2), preferably bisphenol A, in which each of A¹ and A² is p-phenylene and Y¹ is isopropylidene in formula (2). The homopolycarbonate can have an intrinsic viscosity, as determined in chloroform at 25° C., of 0.3-1.5 deciliters per gram (dl/gm), preferably 0.45-1.0 dl/gm. The homopolycarbonate can have a weight average molecular weight (Mw) of 10,000-200,000 grams per mol (g/mol), preferably 20,000-100,000 g/mol, as measured by gel permeation chromatography (GPC), using a crosslinked styrene-divinylbenzene column and calibrated to bisphenol A homopolycarbonate references. GPC samples are prepared at a concentration of 1 mg per ml and are eluted at a flow rate of 1.5 ml per minute. In an aspect, the homopolycarbonate is a bisphenol A homopolycarbonate having a Mw of 18,000-35,000 g/mole, preferably 20,000-25,000 g/mol; a Mw of 25,000-35,000 g/mol, preferably 27,000-32,000 g/mol; or a combination thereof, each as measured as described above.

In an aspect, the polycarbonate is a bisphenol A homopolycarbonate. The bisphenol A homopolycarbonate can have: a melt flow rate of 20-35, preferably 25-30 cm³ per 10 min at 300° C. and a 1.2 kg load and a Mw of 20,000-25,000 g/mole, preferably 21,000-23,000 g/mol; preferably a melt flow rate of 25-30 cm³ per 10 min at 300° C. and a 1.2 kg load and a Mw of 20,000-25,000, g/mole, preferably 21,000-23,000 g/mole, each as measured as described above. In an aspect, the polycarbonate comprises a linear bisphenol A homopolycarbonate. In an aspect, the polycarbonate comprises a linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; or a linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate; or a combination thereof.

The polycarbonate can be present, for example, in an amount of 45 to 90 weight percent, based on the total weight of the thermoplastic composition. Within this range, the polycarbonate can be present in the composition in an amount of 50 to 90 weight percent (wt %), or 60 to 90 wt %, or 65 to 90 wt %, or 70 to 90 wt %, or 50 to 85 wt %, or 65 to 85 wt %, or 70 to 80 wt %, each based on the total weight of the thermoplastic composition. The weight of the thermoplastic composition totals 100 weight percent.

In addition to the polycarbonate, the thermoplastic composition further comprises a brominated polycarbonate. The brominated polycarbonate differs from the polycarbonate. A combination of different brominated polycarbonates can be used. The brominated polycarbonate can be an oligomer or a polymer, and can be derived from an aromatic dihydroxy compound of formula (2) wherein each R^{h} is bromine and n is 1 to 4; or a bisphenol of formula (3), wherein X^{a} is as defined for formula (3), p and q are each independently 0 to 4, provided that the sum of p and q is at least 1, and R^{a} is independently at each occurrence C₁₋₃ methyl, C₁₋₃ alkoxy, or bromine, provided that at least one R^{a} is bromine. In an aspect, a combination of two or more different brominated aromatic dihydroxy compounds can be used. Alternatively, the brominated polycarbonate can be derived from a combination of brominated and non-brominated aromatic dihydroxy compounds. If a non-brominated aromatic dihydroxy compound is used, any of the above-described bisphenols (3) can be used. In an aspect, when a non-brominated aromatic dihydroxy compound is used, the non-brominated aromatic dihydroxy compound can be bisphenol A. If a combination of brominated and non-brominated aromatic dihydroxy compounds is used, then preferably the combination includes at least 25 mole percent (mol %) of the brominated dihydroxy aromatic compound, more preferably at least 25 to 55 mol % of the brominated dihydric phenol, so as to yield a flame retardant brominated polycarbonate. Branched brominated polycarbonate oligomers can also be used, as can compositions of a linear brominated polycarbonate oligomer and a branched brominated polycarbonate oligomer. Combinations of different brominated copolycarbonate oligomers can be used. Exemplary brominated polycarbonates are disclosed in U.S. Pat. No. 4,923,933 to Curry, U.S. Pat. No. 4,170,700 to Orlando et al., and U.S. Pat. No. 3,929,908 to Orlando et al.

The brominated polycarbonate can have a bromine content of 10 to 50 wt %, or 15 to 40 wt %, or 20 to 30 wt %, or 24 to 27.5 wt % each based on the weight of the brominated polycarbonate. Optionally the brominated polycarbonate can have phenol or 2,4,6-tribromophenol endcaps. The brominated polycarbonate can have an intrinsic viscosity of 0.2 to 1.5 deciliter per gram, measured in methylene chloride at 25° C. Within this range, the intrinsic viscosity can be 0.4 to 1 deciliter per gram. The brominated polycarbonate can have a weight average molecular weight of 1,000 to 30,000 g/mol, for example 1,000 to 18,000 g/mol, or 2,000 to 15,000 g/mol, or 3,000 to 12,000 g/mol; or, alternatively 15,000 to 25,000 g/mol, or 20,000 to 25,000 g/mol. The brominated polycarbonates can be branched or linear, or a combination of branched and linear brominated polycarbonates can be used.

In an aspect, the brominated aromatic dihydroxy compound can be 2,2-bis(3,5-dibromo-4-hydroxyphenyl)propane (2′,6,6′-tetrabromo-4,4′-isopropylidenediphenol (TBBPA)), bis(3,5-dibromo-4-hydroxyphenyl)menthanone, or 2,2′,6,6′-tetramethyl-3,3′,5,5′-tetrabromo-4,4′-biphenol; and the non-brominated aromatic dihydroxy compounds for copolymerization with the brominated aromatic dihydroxy compounds include bisphenol A, bis(4-hydroxyphenyl) methane, 2, 2-bis(4-hydroxy-3-methylphenyl)propane, 4,4-bis(4-hydroxyphenyl)heptane, and (3,3′-dichloro-4,4′-dihydroxydiphenyl)methane. In another preferred aspect, the brominated polycarbonate includes brominated carbonate units derived from TBBPA and carbonate units derived from bisphenol A, and more preferably comprises 30 to 70 wt % of TBBPA and 30 to 70 wt % of bisphenol A, or 45 to 55 wt % of TBBPA and 45 to 55 wt % of bisphenol A.

The thermoplastic compositions can include the brominated polycarbonate in an amount of 5 to 15 wt %, based on the total weight of the thermoplastic composition. Within this range, the brominated polycarbonate can be present in an amount of 5 to 12 wt %, or 5 to 10 wt %, or 7 to 12 wt %, or 8 to 12 wt %, or 9 to 11 wt %. In an aspect, the brominated polycarbonate can be used in an amount that contributes 2 to 20 wt % of bromine to the composition, based on the total weight of the composition.

In addition to the polycarbonate and the brominated polycarbonate, the thermoplastic composition further comprises a poly(aliphatic ester-carbonate). Polyester-carbonates further contain, in addition to recurring carbonate units according to formula (1), repeating ester units of formula (4)

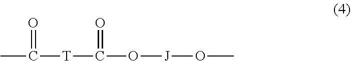

wherein J is a divalent group derived from a dihydroxy compound (which includes a reactive derivative thereof), and can be, for example, a C₁₋₁₀ alkylene, a C₆₋₂₀ cycloalkylene, a C₅₋₂₀ arylene, or a polyoxyalkylene group in which the alkylene groups contain 2 to 6 carbon atoms, preferably, 2, 3, or 4 carbon atoms; and T is a divalent group derived from a dicarboxylic acid (which includes a reactive derivative thereof), and can be, for example, a C₁₋₂₀ alkylene, or a C₅₋₂₀ cycloalkylene. Copolyesters containing a combination of different T or J groups can be used. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,4-cyclohexane diol, 1,4-hydroxymethylcyclohexane, or a combination thereof dihydroxy compounds. Aliphatic dicarboxylic acids that can be used include C₅₋₂₀ aliphatic dicarboxylic acids (which includes the terminal carboxyl groups), preferably linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,4-cyclohexane dicarboxylic acid, or a combination thereof. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example from 1:99 to 99:1, or from 10:90 to 90:10, or from 20:80 to 80:20, or from 1:99 to 50:50, or from 50:50 to 99:1.

A specific example of a poly(ester-carbonate) is a poly(aliphatic ester-carbonate derived from a linear C₆₋₂₀ aliphatic dicarboxylic acid (which includes a reactive derivative thereof), specifically a linear C₆₋₁₂ aliphatic dicarboxylic acid (which includes a reactive derivative thereof). Specific dicarboxylic acids include n-hexanedioic acid (adipic acid), n-decanedioic acid (sebacic acid), and alpha, omega-C₁₂ dicarboxylic acids such as dodecanedioic acid (DDDA). A specific poly(aliphatic ester)-polycarbonate is of formula (5):

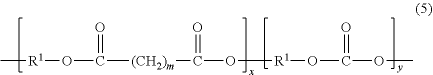

wherein each R¹ can be the same or different, and is as described in formula (1), m is 4 to 18, preferably 4 to 10, and the average molar ratio of ester units to carbonate units x:y is 99:1 to 1:99, including 13:87 to 2:98, or 9:91 to 2:98, or 8:92 to 2:98. In a specific aspect, the poly(aliphatic ester)-polycarbonate copolymer comprises bisphenol A sebacate ester units and bisphenol A carbonate units, having, for example an average molar ratio of x:y of 2:98 to 8:92, for example 6:94. Such poly(aliphatic ester-carbonate)s are commercially available as LEXAN HFD from SABIC.

The poly(aliphatic ester-carbonate) can have a weight average molecular weight of 15,000 to 40,000 grams per mole (g/mol), including 20,000 to 38,000 g/mol. Molecular weight can be determined by gel permeation chromatography (GPC) relative to BPA polycarbonate standards.

The polyester-carbonate can be present in the thermoplastic composition in an amount of 1 to 20 wt %, based on the total weight of the thermoplastic composition. Within this range, the polyester-carbonate can be present in an amount of 5 to 20 wt %, or 5 to 15 wt %, or 7 to 12 wt %, or 8 to 12 wt % or 9 to 11 wt %, each based on the total weight of the thermoplastic composition.

Polycarbonates can be manufactured by processes such as interfacial polymerization and melt polymerization, which are known, and are described, for example, in WO 2013/175448 A1 and WO 2014/072923 A1. An end-capping agent (also referred to as a chain stopper agent or chain terminating agent) can be included during polymerization to provide end groups, for example monocyclic phenols such as phenol, p-cyanophenol, and C₁₋₂₂ alkyl-substituted phenols such as p-cumyl-phenol, resorcinol monobenzoate, and p- and tertiary-butyl phenol, monoethers of diphenols, such as p-methoxyphenol, monoesters of diphenols such as resorcinol monobenzoate, functionalized chlorides of aliphatic monocarboxylic acids such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used. Branched polycarbonate blocks can be prepared by adding a branching agent during polymerization, for example trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt %.

In addition to the polycarbonate, the brominated polycarbonate, and the polyester-carbonate, the thermoplastic composition further comprises a silicone-containing impact modifier. The impact modifier can comprise a core-shell impact modifier. In an aspect, the core-shell impact modifier is a core-shell silicone-(meth)acrylate impact modifier that includes a rubbery silicone core and a grafted rigid (meth)acrylate shell rigid shell. The silicone core can comprise dimethyl siloxane units. The (meth)acrylate monomers used to form the shell are generally a combination of a monofunctional and a copolymerizable polyfunctional (meth)acrylate monomer. Examples of monofunctional (meth)acrylate monomers include branched or straight chain (C₁₋₈ alkyl) (meth)acrylates and glycidyl (meth)acrylate, and examples of copolymerizable polyfunctional monomers include allyl (meth)acrylate, ethylene glycol dimethacrylate, and 1,3-butylene glycol dimethacrylate. Preferred monomers are the C₁₋₆ alkyl methacrylates such as methyl methacrylate. Other monomers can optionally be present in the silicone core or the rigid shell, for example, styrene, α-methylstyrene, halogen or C₁₋₃ alkyl substituted styrene, acrylonitrile, methacrylonitrile, maleic acid, maleic anhydride, C₁₋₄ alkyl and phenyl N-substituted maleimide, divinyl benzene, triallyl cyanurate, triallyl isocyanurate, diallyl phthalate, and the like.

Methods for preparing the core-shell silicone-(meth)acrylate impact modifiers can be as described for example in U.S. Pat. Nos. 7,615,594, 4,888,388, and 4,963,619. The silicone (meth)acrylate impact modifiers can be prepared by emulsion polymerization, wherein, for example a silicone rubber monomer is reacted with a first graft link monomer to form a silicone rubber latex, in the presence of a surfactant such as dodecylbenzenesulfonic acid. Alternatively, a cyclic siloxane such as cyclooctamethyltetrasiloxane and a tetraethoxyorthosilicate can be reacted with a first graft link monomer such as (gamma-methacryloxypropyl)methyl dimethoxysilane. The monofunctional (meth)acrylate monomer is then polymerized with the silicone rubber particles, optionally in presence of a cross linking monomer, such as allyl methacrylate, in the presence of a free radical generating polymerization catalyst such as benzoyl peroxide. In an aspect the impact modifier is prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization and can catalyze transesterification or degradation of polycarbonates. Instead, ionic sulfate, sulfonate, or phosphate surfactants can be used in preparing the impact modifiers, particularly the elastomeric substrate portion of the impact modifiers. Useful surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, or a combination thereof. A specific surfactant is a C₆₋₁₆, preferably a C₈₋₁₂ alkyl sulfonate. This emulsion polymerization process is described and disclosed in various patents and literature of such companies as Dow and General Electric Company.

The core-shell silicone-(meth)acrylate impact modifier can have a rubber content of 30 to 90 wt %; and a silicon core content of 50 to 80 wt %, or 60 to 70 wt %, or 65 to 75 wt %, each based on the total weight of the core-shell silicone-(meth)acrylate impact modifier. The silicone (meth)acrylate impact modifier can have an average particle size of 100 nanometers to 2 micrometers. In an aspect, the particle size is 200 to 400 nm, or greater than 400 nm, or greater than 500 nm.

Exemplary core-shell silicone-(meth)acrylate impact modifiers that can be used include those available commercially, e.g., from Mitsubishi Rayon Co. Ltd., under the trade names METABLEN S-2001, METABLEN S-2100, METABLEN S-2200, and METABLEN S-2501.

The silicone-containing impact modifier can be present in the thermoplastic composition in an amount of 2 to 10 wt %, based on the total weight of the composition. Within this range, the impact modifier can be present in an amount of 3 to 9 wt %, or 4 to 8 wt %, or 4 to 9 wt %, or 5 to 9 wt %, or 5 to 8 wt %, or 6 to 9 wt %, or 6 to 8 wt %, each based on the total weight of the thermoplastic composition.

In an aspect, impact modifiers other than the silicone-containing impact modifier can be minimized or excluded from the composition. For example, the thermoplastic compositions can be substantially free of an α,β-unsaturated glycidyl ester copolymer impact modifier. The α,β-unsaturated glycidyl ester repeating units can have the structure:

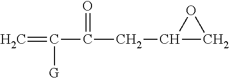

wherein G is hydrogen or a C₁₋₁₀ alkyl. Exemplary α,β-unsaturated glycidyl ester repeating units include glycidyl acrylate, glycidyl methacrylate, and glycidyl ethacrylate. In addition to the α,β-unsaturated glycidyl ester repeating units, the α,β-unsaturated glycidyl ester copolymer can further comprise repeating units derived from an α-olefin, for example ethylene, propylene, 1-butene, and 1-hexene. In an aspect, the α-olefin is ethylene. The α,β-unsaturated glycidyl ester-copolymer can further comprise repeating units derived from a vinyl ester or a C₁₋₁₂ alkyl (meth)acrylate. Examples of vinyl esters include vinyl acetate and vinyl propionate. Examples of alkyl (meth)acrylates include methyl acrylate, ethyl acrylate, butyl acrylate, 2-ethylhexyl acrylate, methyl methacrylate, ethyl methacrylate, butyl methacrylate, and 2-ethylhexyl methacrylate. In an aspect, the C₁₋₁₂ alkyl (meth)acrylate repeating units are methyl acrylate. In an aspect, the α,β-unsaturated glycidyl ester copolymer impact modifier is a copolymer of a α,β-unsaturated glycidyl ester repeating units and α-olefin repeating units. In other aspects, the α,β-unsaturated glycidyl ester copolymer impact modifier is a terpolymer of α,β-unsaturated glycidyl ester repeating units, α-olefin repeating units, and a vinyl ester repeating units, C₁₋₁₂ alkyl (meth)acrylate repeating units, or a combination thereof. In an aspect, the α,β-unsaturated glycidyl ester copolymer impact modifier comprises 60 to 99 wt % α-olefin repeating units, 0.1 to 20 wt % α,β-unsaturated glycidyl ester repeating units, and 0 to 39 wt % of vinyl ester repeating units, C₁₋₁₂ alkyl (meth)acrylate repeating units, or a combination thereof. The α,β-unsaturated glycidyl ester copolymer impact modifiers can include poly(ethylene-co-glycidyl acrylate) (E-GA), poly(ethylene-co-glycidyl methacrylate) (E-GMA), poly(ethylene-co-glycidyl methacrylate-co-methyl acrylate) (E-GMA-MA), poly(ethylene-co-glycidyl methacrylate-co-ethyl acrylate) (E-GMA-EA), poly(ethylene-co-glycidyl methacrylate-co-vinyl acetate) (E-GMA-VA), or a combination thereof. In an aspect, the α,β-unsaturated glycidyl ester copolymer impact modifier is poly(ethylene-co-glycidyl methacrylate), poly(ethylene-co-methyl acrylate-co-glycidyl methacrylate), or a combination thereof. Commercially available α,β-unsaturated glycidyl ester copolymer impact modifiers include LOTADER AX8840 (E-GMA), and LOTADER AX8900, LOTADER AX8920, and LOTADER AX8950 (E-GMA-MA).

The term “substantially free” (e.g., of an α,β-unsaturated glycidyl ester copolymer impact modifier) means 1 wt % or less, 0.5 wt % or less, 0.1 wt % or less, 0.05 wt % or less, 0.01 wt % or less, or less than 0.01 wt %, each based on the total weight of the thermoplastic composition. In an aspect, an α,β-unsaturated glycidyl ester copolymer impact modifier is absent from the thermoplastic compositions.

In addition to the polycarbonate, the brominated polycarbonate, the polyester-carbonate, and the silicone-containing impact modifier, the thermoplastic composition further includes a flame retardant comprising an alkyl sulfonate salt, an aromatic sulfone sulfonate, an aromatic sulfonate salt, or a combination thereof. Alkyl sulfonate salts include, for example salts of C₂₋₁₆ alkyl sulfonates such as potassium perfluorobutane sulfonate (Rimar salt), potassium perfluoroctane sulfonate, and tetraethylammonium perfluorohexane sulfonate. Aromatic sulfonate salts include, for example, sodium benzene sulfonate, sodium toluene sulfonate (NATS), and the like. Salts of aromatic sulfone sulfonates include potassium diphenylsulfone sulfonate (KSS) and the like. In addition to the flame retardant comprising an alkyl sulfonate salt, an aromatic sulfone sulfonate, an aromatic sulfonate salt, or a combination thereof, the thermoplastic compositions can include salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃), or a fluoro-anion complex such as Li₃AlF₆, BaSiF₆, KBF₄, K₃AlF₆, KAlF₄, K₂SiF₆, or Na₃AlF₆ or the like. Rimar salt and KSS and NATS, alone or in combination with other flame retardants, are particularly useful.

The flame retardant comprising an alkyl sulfonate salt, an aromatic sulfone sulfonate, an aromatic sulfonate salt, or a combination thereof can be present in an amount of 0.1 to 1 wt %, based on the total weight of the composition. Within this range, the flame retardant can be present in an amount of 0.1 to 0.5 wt %.

Flame retardants other than the alkyl sulfonate salt, the aromatic sulfone sulfonate, and the aromatic sulfonate salt can be minimized or excluded from the composition. For example, flame retardants other than the alkyl sulfonate salt, the aromatic sulfone sulfonate, and the aromatic sulfonate salt can be present in an amount of less than 1 wt %, or less than 0.5 wt %, or less than 0.1 wt %. In an aspect, flame retardants other than the alkyl sulfonate salt, the aromatic sulfone sulfonate, and the aromatic sulfonate salt are absent from the composition.

The thermoplastic compositions can optionally include titanium dioxide, carbon black, or both. The titanium dioxide, when present, can be included in the composition in an amount of, for example, 0.5 to 10 wt %, or 0.2 to 2 wt %, or 0.5 to 2 wt %, each based on the total weight of the thermoplastic composition. Carbon black, when present, can be included in the composition in an amount of, for example, 0.1 to 1 wt %, or 0.1 to 0.5 wt %, each based on the total weight of the thermoplastic composition.

Additional colorants such as pigment and dye additives other than carbon black and titanium dioxide can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or a combination thereof.

Dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or a combination thereof.

The thermoplastic compositions can include various additives ordinarily incorporated into polymer compositions of this type, with the proviso that the additive(s) are selected so as to not significantly adversely affect the desired properties of a thermoplastic composition, in particular electrical tracking resistance, flame retardant performance, and/or low-temperature impact properties. Such additives can be mixed at a suitable time during the mixing of the components for forming the composition. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives can be used, for example a combination of an anti-drip agent, a UV stabilizer, and a colorant. In general, the additives are used in the amounts generally known to be effective. The additive composition can be present, for example, from 0.01 to 10 wt %, 0.01 to 5.0 wt %, or 0.01 to 3 wt %, each based on the total weight of the thermoplastic composition.

In an aspect, the thermoplastic composition can minimize or exclude other components not specifically described herein. For example, the thermoplastic composition can minimize or exclude any polycarbonate other than the polycarbonate, the brominated polycarbonate, and the polyester-carbonate. For example, a polycarbonate-siloxane copolymer can be present in the composition in an amount of less than 2 wt %, or less than 1 wt %, or less than 0.1 wt %, or can be excluded from the composition. As described above, flame retardants other than the alkyl sulfonate salt, aromatic sulfone sulfonate, and aromatic sulfonate salt can be minimized or excluded from the composition.

In an aspect, the thermoplastic composition comprises 65 to 85 wt % of the polycarbonate comprising a first linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; and a second linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate, wherein a ratio of the first linear bisphenol A polycarbonate homopolymer to the second linear bisphenol A polycarbonate homopolymer is 5:1 to 15:1, preferably 10:1 to 15:1; 7 to 12 wt % of the brominated polycarbonate; 5 to 15 wt % of the polyester-carbonate; 5 to 10 wt % of the silicone-containing impact modifier comprising a core-shell impact modifier; and 0.1 to 1 wt % of the flame retardant comprising an aromatic sulfone sulfonate; and 0.5 to 5 wt % of titanium dioxide; and optionally, 0.1 to 1 wt % of carbon black.

The thermoplastic composition can comprise 45 to 90 weight percent of a polycarbonate; 5 to 15 weight percent of a brominated polycarbonate; 1 to 20 weight percent of a polyester-carbonate; 2 to 10 wt % of a silicone-containing impact modifier; and 0.1 to 1 wt % of a flame retardant comprising an alkyl sulfonate salt, aromatic sulfone sulfonate, an aromatic sulfonate salt, or a combination thereof, wherein the weight percent of each component is based on the total weight of the composition. Optionally, the thermoplastic composition can further comprise 0.5 to 10 weight percent of titanium dioxide; 0.1 to 1 weight percent of carbon black; or both. The polycarbonate can comprise a bisphenol A homopolycarbonate. The polycarbonate can comprise a linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; or a linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate; or a combination thereof. The polycarbonate can comprise a first linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; and a second linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate, wherein a ratio of the first linear bisphenol A polycarbonate homopolymer to the second linear bisphenol A polycarbonate homopolymer is 5:1 to 15:1, preferably 10:1 to 15:1. The brominated polycarbonate can have a bromine content of 24 to 27.5 wt %, based on the total weight of the brominated polycarbonate. Preferably the brominated polycarbonate can comprise brominated bisphenol A polycarbonate units. The flame retardant can comprise potassium perfluorobutane sulfonate, potassium perfluoroctane sulfonate, tetraethylammonium perfluorohexane sulfonate, sodium benzene sulfonate, sodium toluene sulfonate, potassium diphenylsulfone sulfonate, or a combination thereof. Preferably, the flame retardant can comprise potassium diphenylsulfone sulfonate. The impact modifier can comprise a core-shell impact modifier. The impact modifier can comprise a silicone elastomer core and a methyl methacrylate copolymer shell. The thermoplastic composition can further comprise 0.1 to 5 wt % of an additive composition comprising a filler, a reinforcing agent, an antioxidant, a heat stabilizer, a light stabilizer, an ultraviolet light stabilizer, a plasticizer, a lubricant, a mold release agent, an antistatic agent, a colorant, a surface effect additive, a radiation stabilizer, a flame retardant different from an alkyl sulfonate salt or an aromatic sulfonate salt, an anti-drip agent, or a combination thereof. In an aspect, a molded sample of the composition: does not show tracking after at least 50 drops of an aqueous 0.1% ammonium chloride solution measured at 300 volts as determined by ASTM D-3638-85, does not show tracking after at least 50 drops of an aqueous 0.1% ammonium chloride solution measured at 400 volts as determined by ASTM D-3638-85, does not show tracking after at least 50 drops of an aqueous 0.1% ammonium chloride solution measured at 500 volts as determined by ASTM D-3638-85, does not show tracking after at least 50 drops of an aqueous 0.1% ammonium chloride solution measured at 600 volts as determined by ASTM D-3638-85, has a UL 94 flame test rating of V0 at a thickness of 1.5 millimeters; has a UL 94 flame test rating of V0 at a thickness of 1.2 millimeters has a notched Izod impact of greater than 600 joules per meter at −30° C. according to ASTM D256 at a thickness of 3.2 millimeters; has a notched Izod impact of greater than 600 joules per meter at −40° C. according to ASTM D256 at a thickness of 3.2 millimeters; retains greater than 85% of a molecular weight after 1000 hours in a hydrolytic chamber at 85° C. and 85% relative humidity according to ASTM D256; or a combination thereof.

The thermoplastic compositions can be manufactured by various methods known in the art. For example, the powdered polycarbonate(s), and other optional components are first blended, optionally with any fillers, in a high-speed mixer or by hand mixing. The blend is then fed into the throat of a twin-screw extruder via a hopper. Alternatively, at least one of the components can be incorporated into the composition by feeding it directly into the extruder at the throat or downstream through a sidestuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

As discussed above, the thermoplastic compositions are formulated to have excellent physical properties, including excellent hydrolytic stability. Hydrolytic stability concerns the ability of a product to withstand chemical decomposition through hydrolysis, for instance by maintaining molecular weight after prolonged exposure to water. For high-end applications, such as at voltages of 1500, good hydrolytic stability and electrical tracking performance that does not compromise impact and flame retardant performance is desirable.

A molded sample of the thermoplastic composition can retain greater than 85% molecular weight after 1000 hours in a hydrolytic chamber at 85° C. and 85% relative humidity.

A molded sample of the thermoplastic composition can retain at least 60%, preferably at least 70%, 80%, 85%, 90%, or 95% notched Izod impact strength as measured at 23° C. according to ASTM D256 after 1000 hours in a hydrolytic chamber at 85° C. and 85% relative humidity.

The thermoplastic compositions can have excellent electrical tracking performance. The number of drops required to cause tracking can be greater than or equal to 50 drops as determined according to ASTM D-3638-85 from 300 V to 600 V. In an aspect, at 600 V, the number of drops required to cause tracking can be greater than or equal to 50 drops as determined according to ASTM D-3638-85. In an aspect, at 500 V, the number of drops required to cause tracking can be greater than or equal to 50 drops as determined according to ASTM D-3638-85. In an aspect, at 400 V, the number of drops required to cause tracking can be greater than or equal to 50 drops as determined according to ASTM D-3638-85. In an aspect, at 300 V, the number of drops required to cause tracking can be greater than or equal to 50 drops as determined according to ASTM D-3638-85.

A molded sample of the thermoplastic composition can have good low-temperature impact properties. A molded sample of the thermoplastic composition having a thickness of 3.2 millimeters can have a Notched Izod Impact (NII) strength of greater than 600 Joules per meter (J/m) in accordance with ASTM D256 at −30° C. A molded sample of the thermoplastic composition having a thickness of 3.2 millimeters can have a Notched Izod Impact (NII) strength of greater than 600 Joules per meter (J/m) in accordance with ASTM D256 at −40° C.

A molded sample can have a UL-94 flammability test rating of V0 at a thickness of 1.5 millimeter, a UL-94 flammability test rating of V0 at a thickness of 1.2 millimeter, or a combination thereof.

Shaped, formed, or molded articles comprising the polycarbonate compositions are also provided. The thermoplastic compositions can be molded into useful shaped articles by a variety of methods, such as injection molding, extrusion, rotational molding, blow molding and thermoforming. Some examples of articles include computer and business machine housings such as housings for monitors, handheld electronic device housings such as housings for cell phones, electrical connectors, and the like. In addition, the polycarbonate compositions can be used for such applications as electronic components, preferably electronic connectors.

This disclosure is further illustrated by the following examples, which are non-limiting.

### EXAMPLES

Materials used for the following Examples are shown in Table 1.

TABLE 1

| Component | Description | Source |
|---|---|---|
| PC-1 | Linear bisphenol A polycarbonate, CAS Reg. No, 25971-63-5, having a molecular | SABIC |
| | weight (Mw) of 30,000-31,000 grams per mole, as determined by gel permeation | |
| | chromatography using polystyrene standards and calculated for polycarbonate, | |
| | produced by interfacial polymerization and endcapped with p-cumylphenol | |
| PC-2 | Linear bisphenol A polycarbonate having a Mw of 20,000-22,000 grams per mole, | SABIC |
| | as determined by gel permeation chromatography using polystyrene standards and | |
| | calculated for polycarbonate, produced by interfacial polymerization and | |
| | endcapped with p-cumylphenol | |
| PEC | Bisphenol A-sebacic acid copolycarbonate having a Mw of 21,000 to 22,000 | SABIC |
| | grams per mole, as determined by gel permeation chromatography using | |
| | polystyrene standards and calculated for polycarbonate, produced by interfacial | |
| | polymerization, having a sebacic acid content of 5 to 7% and endcapped with p- | |
| | cumylphenol | |
| Br-PC | BPA-co-2,6-tetrabromo BPA copolycarbonate, CAS Reg. No. 156042-31-8, 26 | SABIC |
| | wt % bromine content, Mw = 22,000-24,000 g/mol as per GPC using polystyrene | |
| | standards and calculated for polycarbonate. | |
| UVA234 | 2-(2-hydroxy-3,5-di-cumyl)benzotriazole, CAS Reg. No. 70321-86-7 | CIBA |
| IM-Si | Core-shell impact modifier having a silicone elastomer core and a | MITSUBISHI |
| | methyl(methacrylate) (MMA) copolymer shell, CAS Reg. No. 143106-82-5, | RAYON CO |
| | having a particle size of 200-400 nm, available as METABLEN S-2501 | |
| KSS | Potassium diphenylsulfone sulfonate, CAS Reg. No. 63316-43-8 | Arichem |
| TSAN | Encapsulated Polytetrafluoroethy lene, CAS Reg. No. 9002-84-0, having the | SABIC |
| | tradename TSAN, with 47-53 wt % poly(tetrafluoroethylene) | |
| PETS | Pentaerythritol tetrastearate, >90% esterified | Faci |
| Phosphite | Tris(2,4-di-tert-butylphenyl) phosphite, available as IRGAFOS 168 | BASF |
| TiO₂ | Titanium dioxide, CAS No. 13463-67-7 | Kronos |
| CB | Carbon black, CAS No. 1333-86-4 | Cabot |

The testing samples were prepared as described below and the following test methods were used.

Typical compounding procedures are described as follows: All raw materials are pre-blended and then extruded using a twin extruder. The composition was melt-kneaded, extruded, cooled through a water bath and pelletized. A typical extrusion profile is listed in Table 2.

TABLE 2

| Parameter | Unit | Value |
|---|---|---|
| Die | mm | 3 |
| Zone 1 Temp | ° C. | 50 |
| Zone 2 Temp | ° C. | 100 |
| Zone 3-11 Temp | ° C. | 270 |
| Die Temp | ° C. | 270 |
| Screw speed | rpm | 400 |
| Throughput | kg/hr | 40 |
| Side feeder speed | rpm | 250 |

The extruded pellets were molded into testing specimens after drying the extruded pellets at 120° C. for 3 hours using injection molding, as shown in Table 3.

TABLE 3

| Parameters | Unit | CTI test chip | Izod bar | Flame bar |
|---|---|---|---|---|
| Cnd: Pre-drying time | Hour | 3 | 3 | 3 |
| Cnd: Pre-drying temp | ° C. | 120 | 120 | 120 |
| Hopper temp | ° C. | 50 | 50 | 50 |
| Zone 1 temp | ° C. | 300 | 275 | 300 |
| Zone 2 temp | ° C. | 300 | 280 | 300 |
| Zone 3 temp | ° C. | 300 | 285 | 300 |
| Nozzle temp | ° C. | 300 | 280 | 300 |
| Mold temp | ° C. | 100 | 75 | 100 |
| Screw speed | rpm | 100 | 100 | 100 |
| Back pressure | kgf/cm² | 68 | 68 | 68 |
| Injection speed | mm/s | 30 | 30 | 30 |
| Max. injection pressure | kgf/cm² | 1200 | 1200 | 1200 |
| Molding Machine | NONE | FANUC | FANUC | Netstal |
| Mold Type | NONE | Color chip | Axxicon Izod | ULA-1.5 mm |
| | | step 1/2 | | |

Sample preparation and testing methods are described in Table 4.

TABLE 4

| Property | Standard | Conditions | Specimen Type |
|---|---|---|---|
| Mw | SABIC | GPC | Bar-63.5 mm × 12.7 mm × 3.2 mm |
| MVR | ASTM D1238- | 300° C. using a 1.2-kilogram | |
| | 04 | weight, over 10 minutes | |
| CTI | ASTM D3638 | 300 V, 400 V, 500 V, 600 V | Color chip-90 mm × 1 mm/2 mm |
| Tensile | ASTM D638 | 23° C., 3.2 mm | Bar- 57.00*13.00*3.18*166 mm |
| Notched Izod | ASTM D256 | 23° C., −30° C., and −40° C., | Bar-63.5 mm × 12.7 mm × 3.2 mm |
| | | 3.2 mm | |
| Flammability | UL 94 | Vertical Burning | Bar-127 mm × 12.7 mm × 3 mm/1 mm |

For hydrolytic stability assessments, Izod bars were placed into a hydrolytic chamber at 85° C. and 85% relative humidity (RH for pre-determined time intervals. The samples were then removed from the ovens for characterization of molecular weight (Mw) and impact properties. Hydrolytic stability was assessed by comparison of the weight average molecular weight of polycarbonate before and after hydrolytic stress as described above. The data was converted to % retention of the initial Mw and the data are shown in the following tables. Mw was determined by gel permeation chromatography (GPC). Hydrolytic stability was assessed by comparison of Notched Izod impact strength (NII) at 23° C. of a formulation before and after hydrolytic stress.

Flammability tests were performed on samples at thicknesses of 1.5 and 1.2 mm in accordance with the Underwriter's Laboratory (UL) UL 94 standard. The following definitions are used as shown in Table 5. Total flame-out-times for all 5 bars (FOT=t1+t2) were determined. V-ratings were obtained for every set of 10 bars.

TABLE 5

| | t₁ and/or t₂ | 5-bar FOT | burning drips |
|---|---|---|---|
| V0 | <10 | <50 | no |
| V1 | <30 | <250 | No |
| V2 | <30 | <250 | Yes |
| N.R. (no rating) | >30 | >250 | |

Compositions are rated as “pass” or “fail” for the flame test ratings. “Pass” means that the flame test rating was V0 at the indicated thickness. “Fail” means that the composition had either a V1 rating, a V2 rating, or no rating as defined in Table 5.

Table 6 shows the compositions and properties for Examples 1-5. The amount of each component is provided as weight percent (wt %) based on the total weight of the composition. Comparative examples are indicated with “*”.

TABLE 6

| Components | Units | E1* | E2* | E3* | E4 | E5 |
|---|---|---|---|---|---|---|
| PC-1 | wt % | 83.74 | 78.44 | 75.44 | 65.44 | 65.74 |
| PC-2 | wt % | 5 | 5 | 5 | 5 | 5 |
| PEC | wt % | 0 | 0 | 0 | 10 | 10 |
| Br PC | wt % | 5 | 8 | 10 | 10 | 10 |
| IM-Si | wt % | 5 | 6 | 7 | 7 | 7 |
| KSS | wt % | 0.3 | 0.3 | 0.3 | 0.3 | 0.3 |
| PETS | wt % | 0.3 | 0.3 | 0.3 | 0.3 | 0.3 |
| UVA | wt % | 0.3 | 0.3 | 0.3 | 0.3 | 0.3 |
| TSAN | wt % | 0.3 | 0.3 | 0.3 | 0.3 | 0.3 |
| Phosphite | wt % | 0.06 | 0.06 | 0.06 | 0.06 | 0.06 |
| CB | wt % | 0 | 0.3 | 0.3 | 0.3 | 0 |
| TiO₂ | wt % | 0 | 1 | 1 | 1 | 1 |
| Total | wt % | 100 | 100 | 100 | 100 | 100 |
| V0 UL-94 | | Fail | Pass | Pass | Pass | Pass |
| flame test | | | | | | |
| rating, | | | | | | |
| 1.5 mm | | | | | | |
| V0 UL-94 | | Fail | Fail | Fail | Pass | Pass |
| flame test | | | | | | |
| rating, | | | | | | |
| 1.2 mm | | | | | | |
| NII, 23° C. | J/m | 823 | 811 | 793 | 769 | 777 |
| NII, −30° C. | J/m | 727 | 700 | 704 | 711 | 644 |
| NII, −40° C. | J/m | 355 | 369 | 640 | 604 | 620 |
| CTI 300 V | average | 44 | 73 | 65 | 97 | 75 |
| | drops | | | | | |
| CTI 400 V | average | | 100 | 65 | 100 | 76 |
| | drops | | | | | |
| CTI 500 V | average | | 100 | 100 | 100 | 100 |
| | drops | | | | | |
| CTI 600 V | average | 66 | 100 | 100 | 100 | 100 |
| | drops | | | | | |
| Mw retention, | | | | | | 91% |
| DH85 1000 h | | | | | | |
| Mw retention, | | | | | | 78% |
| DH85 2000 h | | | | | | |

*Comparative Examples

As shown in Table 6, in Examples 4 and 5, when PC-3 (bisphenol A-sebacic acid copolymer) included in the composition, a tracking resistance of greater than or equal to 50 drops as determined according to ASTM D-3638-85 at 300 V to 600 V can be achieved. Advantageously, the compositions including PC-3 could provide a UL-94 flame test rating of V0 at a thickness of 1.2 mm, which could not be achieved in the Comparative Examples 1-3. Therefore, in the absence of the bisphenol A-sebacic acid copolymer, achieving (1) a UL-94 flame test rating of V0 at a thickness of 1.2 mm, (2) a low-temperature impact resistance of greater than 600 J/m at both −30° C. and −40° C., and (3) a tracking resistance of greater than or equal to 50 drops as determined according to ASTM D-3638-85 at 300 V to 600 V could not be achieved. In contrast, the compositions according to Examples 4 and 5, each including the bisphenol A-sebacic acid copolymer, provided the desired combination of properties.

This disclosure further encompasses the following aspects.

Aspect 1: A thermoplastic composition comprising: 45 to 90 weight percent of a polycarbonate; 5 to 15 weight percent of a brominated polycarbonate; 1 to 20 weight percent of a polyester-carbonate; 2 to 10 wt % of a silicone-containing impact modifier; and 0.1 to 1 wt % of a flame retardant comprising an alkyl sulfonate salt, aromatic sulfone sulfonate, an aromatic sulfonate salt, or a combination thereof, wherein the weight percent of each component is based on the total weight of the composition.

Aspect 2: The thermoplastic composition of aspect 1, further comprising 0.5 to 10 weight percent of titanium dioxide; 0.1 to 1 weight percent of carbon black; or both.

Aspect 3: The thermoplastic composition of aspect 1 or 2, wherein the polycarbonate comprises a bisphenol A homopolycarbonate.

Aspect 4: The thermoplastic composition of any of aspects 1 to 3, wherein the polycarbonate comprises a linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; or a linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate; or a combination thereof.

Aspect 5: The thermoplastic composition of any of aspects 1 to 4, wherein the polycarbonate comprises a first linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; and a second linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate, wherein a ratio of the first linear bisphenol A polycarbonate homopolymer to the second linear bisphenol A polycarbonate homopolymer is 5:1 to 15:1, preferably 10:1 to 15:1.

Aspect 6: The thermoplastic composition of any of aspects 1 to 5, wherein the brominated polycarbonate has a bromine content of 24 to 27.5 wt %, based on the total weight of the brominated polycarbonate, preferably wherein the brominated polycarbonate comprises brominated bisphenol A polycarbonate units.

Aspect 7: The thermoplastic composition of any of aspects 1 to 6, wherein the flame retardant comprises potassium perfluorobutane sulfonate, potassium perfluoroctane sulfonate, tetraethylammonium perfluorohexane sulfonate, sodium benzene sulfonate, sodium toluene sulfonate, potassium diphenylsulfone sulfonate, or a combination thereof, preferably potassium diphenylsulfone sulfonate.

Aspect 8: The thermoplastic composition of any of aspects 1 to 7, wherein the impact modifier comprises a core-shell impact modifier.

Aspect 9: The thermoplastic composition of any of aspects 1 to 8, wherein the impact modifier comprises a silicone elastomer core and a methyl methacrylate copolymer shell.

Aspect 10: The thermoplastic composition of any of aspects 1 to 9, wherein the polyester-carbonate comprises a bisphenol A-sebacic acid copolycarbonate.

Aspect 11: The thermoplastic composition of any of aspects 1 to 10, wherein the thermoplastic composition further comprises 0.1 to 5 wt % of an additive composition comprising a filler, a reinforcing agent, an antioxidant, a heat stabilizer, a light stabilizer, an ultraviolet light stabilizer, a plasticizer, a lubricant, a mold release agent, an antistatic agent, a colorant, a surface effect additive, a radiation stabilizer, a flame retardant different from an alkyl sulfonate salt or an aromatic sulfonate salt, an anti-drip agent, or a combination thereof.

Aspect 12: The thermoplastic composition of any of aspects 1 to 11, wherein a molded sample of the composition: does not show tracking after at least 50 drops of an aqueous 0.1% ammonium chloride solution measured at 300 volts as determined by ASTM D-3638-85, does not show tracking after at least 50 drops of an aqueous 0.1% ammonium chloride solution measured at 400 volts as determined by ASTM D-3638-85, does not show tracking after at least 50 drops of an aqueous 0.1% ammonium chloride solution measured at 500 volts as determined by ASTM D-3638-85, does not show tracking after at least 50 drops of an aqueous 0.1% ammonium chloride solution measured at 600 volts as determined by ASTM D-3638-85, has a UL 94 flame test rating of V0 at a thickness of 1.5 millimeters; has a UL 94 flame test rating of V0 at a thickness of 1.2 millimeters has a notched Izod impact of greater than 600 joules per meter at −30° C. according to ASTM D256 at a thickness of 3.2 millimeters; has a notched Izod impact of greater than 600 joules per meter at −40° C. according to ASTM D256 at a thickness of 3.2 millimeters; retains greater than 85% of a molecular weight after 1000 hours in a hydrolytic chamber at 85° C. and 85% relative humidity according to ASTM D256; or a combination thereof.

Aspect 13: The thermoplastic composition of any of aspects 1 to 12, comprising 65 to 85 weight percent of the polycarbonate comprising a first linear bisphenol A polycarbonate homopolymer having a weight average molecular weight of 26,000 to 40,000 grams per mole, preferably 27,000 to 35,000 grams per mole, as determined by gel permeation chromatography using polystyrene standards and calculated for polycarbonate; and a second linear bisphenol A polycarbonate homopolymer having a weight average molecular weight of 15,000 to 25,000 grams per mole, preferably 17,000 to 25,000 grams per mole, as determined by gel permeation chromatography using polystyrene standards and calculated for polycarbonate, wherein a ratio of the first linear bisphenol A polycarbonate homopolymer to the second linear bisphenol A polycarbonate homopolymer is 5:1 to 15:1, preferably 10:1 to 15:1; 7 to 12 weight percent of the brominated polycarbonate; 5 to 15 weight percent of the polyester-carbonate; 5 to 10 wt % of the silicone-containing impact modifier comprising a core-shell impact modifier; and 0.1 to 1 wt % of the flame retardant comprising an aromatic sulfone sulfonate; and 0.5 to 5 weight percent of titanium dioxide; and optionally, 0.1 to 1 weight percent of carbon black.

Aspect 14: An article comprising the thermoplastic composition of any of aspects 1 to 13, preferably wherein the article is an electrical component, more preferably an electrical connector.

Aspect 15: A method for forming the article according to aspect 14, the method comprising molding, casting, or extruding the thermoplastic composition to provide the article.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
45 to 90 weight percent of a polycarbonate;
5 to 15 weight percent of a brominated polycarbonate;
1 to 20 weight percent of a poly(aliphatic ester-carbonate);
2 to 10 wt % of a silicone-containing impact modifier; and
0.1 to 1 wt % of a flame retardant comprising an alkyl sulfonate salt, aromatic sulfone sulfonate, an aromatic sulfonate salt, or a combination thereof;
wherein the weight percent of each component is based on the total weight of the composition.

2. The thermoplastic composition of claim 1, further comprising
0.5 to 10 weight percent of titanium dioxide:
0.1 to 1 weight percent of carbon black; or both.

3. The thermoplastic composition of claim 1, wherein the polycarhonate comprises a bisphenol A homopolycarbonate.

4. The thermoplastic composition of claim 1, wherein the polycarbonate comprises
a linear bisphenol A polycarbonate homopolyner having a weight average molecular weight of 26,000 to 40,000 grams per mole as determined by gel permeation chromatography using polystyrene standards and calculated for polycarbonate; or
a linear bisphenol A polycarbonate homopolymer having a weight average molecular weight of 15,000 to 25,000 grams per mole as determined by gel permeation chromatography using polystyrene standards and calculated for polycarbonate; or
a combination thereof.

5. The thermoplastic composition of claim 1, wherein the polycarbonate comprises
a first linear bisphenol A polycarbonate homopolymer having a weight average molecular weight of 26,000 to 40,000 grams per mole as determined by gel permeation chromatography using polystyrene standards and calculated for polycarbonate; and
a second linear bisphenol A polycarbonate homopolymer having a weight average molecular weight of 15,000 to 25,000 grains per mole as determined by gel permeation chromatography using polystyrene standards and calculated for polycarbonate,
wherein a ratio of the first linear bisphenol A polycarbonate homopolymer to the second linear bisphenol A polycarbonate homopolymer is 5:1 to 15:1.

6. The thermoplastic composition of claim 1, wherein the brominated polycarbonate has a bromine content of 24 to 27.5 wt %, based on the total weight of the brominated polycarbonate.

7. The thermoplastic composition of claim 1, wherein the flame retardant comprises potassium perfluorobutane sulfonate, potassium perfluoroctane sulfonate, tetraethylammonium perfluorohexane sulfonate, sodium benzene sulfonate, sodium toluene sulfonate, potassium diphenylsulfone sulfonate, or a combination thereof.

8. The thermoplastic composition of claim 1, wherein the impact modifier comprises a core-shell impact modifier.

9. The thermoplastic composition of claim 1, wherein the impact modifier comprises a silicone elastomer core and a methyl methacrylate copolymer shell.

10. The thermoplastic composition of claim 1, wherein the poly(aliphatic estercarbonate) comprises a bisphenol A-sebacic acid copolycarbonate.

11. The thermoplastic composition of claim 1, wherein the thermoplastic composition further comprises 0.1 to 5 wt % of an additive composition comprising a filler, a reinforcing agent, an antioxidant, a heat stabilizer, a light stabilizer, an ultraviolet light stabilizer, a plasticizer, a lubricant, a mold release agent, an antistatic agent, a colorant, a surface effect additive, a radiation stabilizer, a flame retardant different from an alkyl sulfonate salt or an aromatic sulfonate salt, an anti-drip agent, or a combination thereof.

12. The thermoplastic composition of claim 1, wherein a molded sample of the composition:
does not show tracking after at least 50 drops of an aqueous 0.1% ammonium chloride solution measured at 300 volts as determined by ASTM D-3638-85,
does not show tracking after at least 50 drops of an aqueous 0.1% ammonium chloride solution measured at 400 volts as determined by ASTM D-3638-85,
does not show tracking after at least 50 drops of an aqueous 0.1% ammonium chloride solution measured at 500 volts as determined by ASTM D-3638-85,
does not show tracking after at least 50 drops of an aqueous 0.1% ammonium chloride solution measured at 600 volts as determined by ASTM D-3638-85,
has a UL 94 flame test rating of V0 at a thickness of 1.5 millimeters;
has a UL 94 flame test rating of V0 at a thickness of 1.2 millimeters
has a notched Izod impact of greater than 600 joules per meter at −30° C. according to ASTM D256 at a thickness of 3.2 millimeters;
has a notched Izod impact of greater than 600 joules per meter at −40° C. according to ASTN D256 at a thickness of 3.2 millimeters;
retains greater than 85% of a molecular weight after 1000 hours in a hydrolytic chamber at 85° C. and 85% relative humidity according to ASTM D256;
or a combination thereof.

13. The thermoplastic composition of claim 1, comprising 65 to 85 weight percent of the polycarbonate comprising
a first linear bisphenol A polycarbonate homopolymer having a weight average molecular weight of 26,000 to 40,000 grams per mole, as determined by gel permeation chromatography using polystyrene standards and calculated for polycarbonate; and
a second linear bisphenol A polycarbonate homopolymer having a weight average molecular weight of 15,000 to 25,000 grams per mole, as determined by gel permeation chromatography using polystyrene standards and calculated for polycarbonate,
wherein a ratio of the first linear bisphenol A polycarbonate homopolymer to the second linear bisphenol A polycarbonate homopolymer is 5:1 to 15:1;
7 to 12 weight percent of the brominated polycarbonate;
5 to 15 weight percent of the poly(aliphatic ester-carbonated;
5 to 10 wt % of the silicone-containing impact modifier comprising a core-shell impact modifier; and
0.1 to 1 wt % of the flame retardant comprising an aromatic sulfone sulfonate; and
0.5 to 5 weight percent of titanium dioxide; and
optionally, 0.1 to 1 weight percent of carbon black.

14. An article comprising the thermoplastic composition of claim 1.

15. A method for forming the article according to claim 14, the method comprising molding, casting, or extruding the thermoplastic composition to provide the article.
